(19) United States
(12) Patent Application Publication
(10) Pub. No.: US 2019/0271872 A1
(43) Pub. Date: Sep. 5, 2019

(54) DISPLAY SEALING TECHNIQUE

(71) Applicant: FlexEnable Limited, Cambridge (GB)

(72) Inventor: Paul CAIN, Cambridge (GB)

(21) Appl. No.: 16/285,851

(22) Filed: Feb. 26, 2019

(30) Foreign Application Priority Data
Mar. 1, 2018 (GB) 1803366.2

(51) Int. Cl. G02F 1/1339; G02F 1/1337

(52) U.S. Cl. CPC G02F 1/13392; G02F 2001/13398; G02F 1/133788; G02F 1/13394

(57) ABSTRACT

We disclose herein a display device comprising a first plate, a second plate spaced apart from the first plate to form a cell gap between the first and second plates, a display medium material and a radiation curable material located within the cell gap. Upon exposure to radiation within a vicinity of a continuous target perimeter, the radiation curable material is configured to bond the first and second plates together within the vicinity of the continuous target perimeter.

### RELATED APPLICATIONS

The present invention is a U.S. Non-Provisional patent application, claiming priority to UK Serial No. 1803366.2, filed on 1 Mar. 2018, the entirety of which is incorporated herein by reference.

### TECHNICAL FIELD

The present disclosure relates to a display sealing technique.

### BACKGROUND

Currently no displays are made with a high degree of perforation, either because they are made from glass (for which perforation would be difficult), or because for flexible OLED displays, encapsulation requirements are extremely high and have a high proportion of edge which would reduce lifetime or manufacturing yield

Furthermore, conventional sealing techniques using glues or adhesives are slow and would struggle for sealing display devices having a complex (e.g. corrugated) structure.

### SUMMARY

According to one aspect of the present disclosure, there is provided a display device comprising: a first plate, a second plate spaced apart from the first plate to form a cell gap between the first and second plates, a display medium material and a radiation curable material located within the cell gap. Upon exposure to radiation within a vicinity of a continuous target perimeter, the radiation curable material is configured to bond the first and second plates together within the vicinity of the continuous target perimeter. Here the term continuous target perimeter refers to a continuous (or un-interrupted) boundary of an area. It generally means a peripheral boundary of a region. The continuous target perimeter could be the external boundary of a display device. The continuous target perimeter could be the perimeter of a hole through the display device. This means that the continuous target perimeter acts as an internal seal of one or more holes within the display device. The continuous target perimeter is generally located all around the target area (e.g., edge of the display and/or edges of the holes). The term ‘vicinity’ refers to on, near, around, or proximal to the continuous target perimeter.

Here the display medium material is generally liquid crystal material. Other display materials are generally covered as well. The display device generally has two plates which could be substrates. Alternatively, the plates could be operatively connected to the corresponding substrates. It would be appreciated that both scenarios are within the scope of the present disclosure.

Forming a bonding spacer wall using radiation in the vicinity of the continuous target area is generally advantageous because it helps to bond both plates (or substrates). This helps to improve bonding tolerance of LCDs. When the plates (or substrates) are flexed, the bonding spacer walls improve image quality as they bond both plates (substrates) together. Using (light) radiation (or a light beam) to enable the curable material to form the bonding spacers is advantageous because it is easier, faster and more accurate to control the light radiation over the target perimeter (compared to the conventional method using an adhesive/glue). Similarly, it is also easier, faster and more accurate to define the target perimeter as desired using the light radiation (e.g., UV radiation) technique. This is because the light radiation technique is quick and fast to control as desired. When there is a need to make high number of holes within the display device, using the bonding wall spacers to make the hole sealing and/or display external sealing is advantageous. This is because the UV radiation can be easily and conveniently used to define a large number of areas for desired perforations or holes within the display. This disclosure offers advantage for all LCD display types that could be perforated—which effectively means all plastic-based LCDs (for example, Japan Display or JDI approach could benefit from this in the event when perforation is required). It would be appreciated that the proposed technique is not limited LCDs, but it can be used to other display types as well.

Forming a through-hole (or a perforation) within the display device is advantageous for placing a light source within the hole. The through-hole can help to maintain the high degree of light transmission. For example, the display could be wrapped across a vehicle and the large number of holes in the display will be advantageous. In a further example, when a sound speaker is provided in the hole of the display, sound can pass through the hole more easily. This is particularly useful when a display is wrapped around a speaker and a large number of holes are necessary in the display. The technique proposed in this disclosure can be suitable for such applications.

The vicinity of the continuous target perimeter may be an area of the display device in which one side of the area has the liquid crystal material and another side of the area has no liquid crystal material. This technique is particularly useful to make the external sealing for the LC material and/or the display device. When the technique is used to form the external sealing of the display, one side has the LC display and another side has no display area because that side has been cut out (e.g. by laser profiling) to form the display sealing.

The vicinity of the continuous target perimeter may be an area of the display device in which one side of the area has the liquid crystal material and the other side of the area has no display. The other side of the area may be a hole through the display device. In one example, the other side of the area may be outside the display device.

The radiation curable material may be configured to form at least one bonding wall spacer to bond the first and second plates (substrates). The at least one bonding wall spacer may be a polymer wall. In one example, the polymer wall spacers are constructed to rigidly bond two plates or substrates and are to increase the bending tolerance of LCDs. The polymer spacer walls under, for example, UV radiation are patterned with an orthogonal latticed photomask.

During this technique (or process), molecules of the drifted cured material (mixed with LC material) move towards the UV irradiated regions of the solution. In one example, this photo-polymerization induced phase separation phenomenon causes the networking of the polymer spacer walls to be segregated into the UV exposed areas. The curable material (e.g., polymer) aggregation or accumulation then forms a condensed wall spacer that creates the bond between the two substrates (or plates) in the desired regions. The desired regions in this instance are the perimeter of the holes within the display and/or the perimeter of the entire display device. Therefore, the accumulated wall spacer forms the internal sealing for the LC materials and/or the external sealing of the entire display device.

The continuous target perimeter may be an outer perimeter of the display device.

The continuous target perimeter may be a perimeter of a perforated region within the display device. The perforated region may be a hole through the first substrate, the liquid crystal material in the cell gap and the second substrate. Advantageously, a large number of holes can be created within the display device using this technique, as emitting UV radiation is generally very fast and accurate to define the desired regions, and the processing time is generally independent of the number of holes required.

The device may be configured such that holes and/or edges in the target continuous perimeter are cut using a laser profiling technique. Alternatively, the substrates can be cut out by a blade or die. In this example, the substrates are generally made with plastic so that laser profiling or blade can be conveniently used.

According to another aspect of the present disclosure, there is provided a method of manufacturing a display device. The method comprising: forming a first plate; forming a second plate spaced apart from the first plate to form a cell gap between the first and second plates; depositing a display medium material and a radiation curable material within the cell gap; radiating the display medium material and the radiation curable material within a vicinity of a continuous target perimeter so that the radiation curable material bonds the first and second plates together within the vicinity of the continuous target perimeter.

The vicinity of the continuous target perimeter may be an area of the display device in which one side of the area has the display medium material and another side of the area has no display medium.

The vicinity of the continuous target perimeter may be an area of the display device in which one side of the area has the display medium material and another side of the area has no display.

The method may further comprise forming at least one bonding wall spacer from the radiation curable material to bond the first and second plates.

The continuous target perimeter may be an outer perimeter of the display device.

The continuous target perimeter may be a perimeter of a perforated region within the display device.

The perforated region may be a hole through the first plate, the liquid crystal material in the cell gap and the second plate.

The method may further comprise applying a patterned radiation to define the continuous target perimeter where the edge of the display device will be formed.

The method may further comprise applying a patterned radiation to define the continuous target perimeter where a perforated region within the display device will be formed.

The method may further comprise forming bonding spacer wall in the continuous target perimeter.

The method may further comprise applying a laser profiling technique to form a hole through the device.

The method may further comprise applying a laser profiling technique to form an edge seal of the display device.

### BRIEF DESCRIPTION OF THE DRAWINGS

Some preferred embodiments of the disclosure will now be described by way of an example only and with reference to the accompanying drawings, in which:

FIG. 1 illustrates a schematic cross-sectional view of a conventional structure of a liquid crystal display;

FIG. 2 illustrates a schematic cross-sectional view of a LCD structure having a hole through all the layers of the display device;

FIG. 3 generally illustrates the manufacturing steps of the display device according to one embodiment of the present disclosure, in which:

FIG. 3(a) illustrates a first step of assembling a display cell according to one embodiment;

FIG. 3(b) illustrates a second step of assembling a display cell;

FIG. 3(c) illustrates a third step of the manufacturing process in which patterned light radiation is used to a desired location for forming a bonding wall spacer;

FIG. 3(d) illustrates a fourth step of the manufacturing process in which a bonding spacer wall is formed connecting plates operatively connected with the first and second substrates;

FIG. 3(e) illustrates a fifth step of the manufacturing process in which the display is cut away after forming the bonding spacer wall;

FIG. 3(f) illustrates a display device after an edge is sealed using the bonding spacer wall after the display is cut away;

FIG. 4 illustrates the manufacturing steps of forming holes in the display device;

FIG. 5 illustrates a display device with a larger perimeter according to one embodiment, and

FIG. 6 illustrates a display device with a plurality of holes or perforations across the device.

### DETAILED DESCRIPTION OF THE PREFERRED EMBODIMENTS

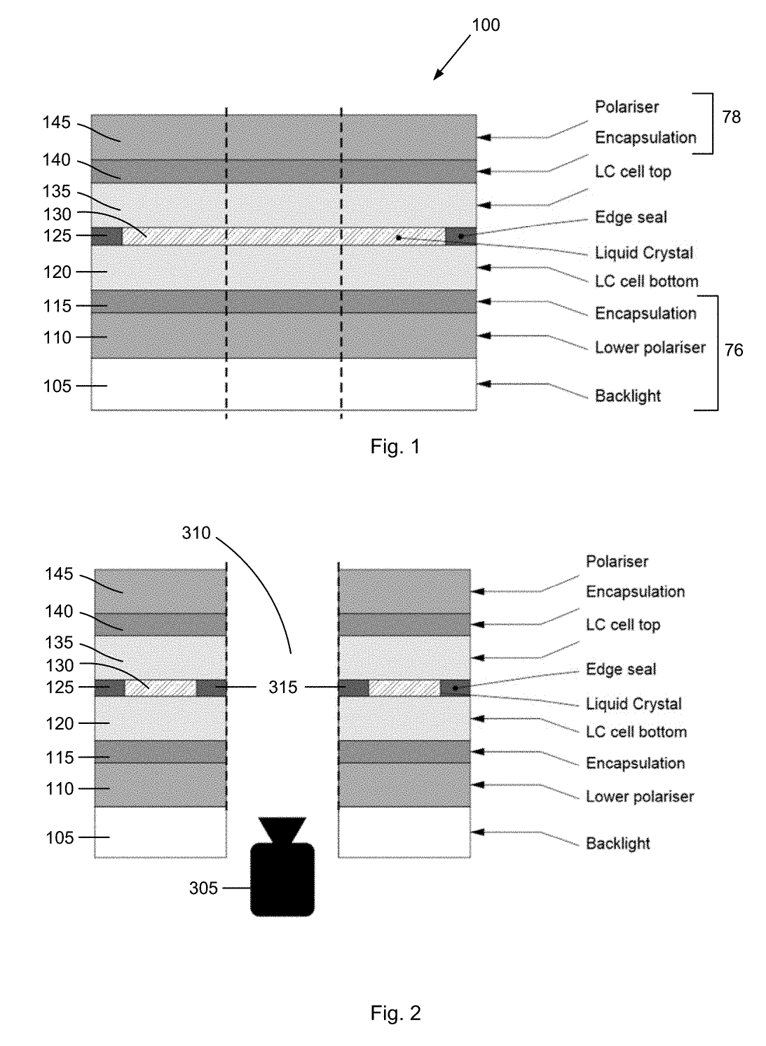

FIG. 1 illustrates a schematic cross-sectional view of a conventional structure of a liquid crystal display 100. In this known structure 100, liquid crystal (LC) material 130 is disposed between a bottom (or first) encapsulation layer 115 and a top (or second) encapsulation layer 140. The LC material 130 is sandwiched by a LC cell top layer (or a first substrate) 135 and a LC cell bottom layer (or a second substrate) 120. An edge seal 125 is provided on both sides of the LC material 130. The LC layers are generally driven by control circuitry (not shown in FIG. 1), for example, thin film transistors (TFTs) and associated electrical connections, disposed on the LC cell bottom 120. The control circuitry generally includes an array of thin film transistors (TFTs).

In the structure of FIG. 1, a first polariser film or layer 110 is provided below the bottom encapsulation layer 115. A backlight layer 105 is provided below the first polariser film 110. In the example of FIG. 1, the LC cell bottom 120 and LC cell top 140 are generally made of TAC (Cellulose Triacetate). The bottom encapsulation layer 115 and the first polariser film 110 generally form part of a driver component 76 of the display structure 100. The backlight layer 105 is generally a separate part.

In the structure of FIG. 1, a second polariser film 145 is provided on the top encapsulation layer 140. In one example, one side of the top encapsulation layer 140 there is provided a colour filter layer (not shown). It will be appreciated that in a conventional LCD the colour filter resides on the “LC cell top” layer 135.

In the structure of FIG. 1, two dashed lines show a target area where a hole or perforation can be made within the LCD structure 100.

FIG. 2 illustrates a schematic cross-sectional view of a LCD structure having a hole through all the layers of the display device. Many features of FIG. 2 are the same as those shown in FIG. 1 and therefore carry the same reference numbers. However, in the structure of FIG. 2, a hole (or a perforation) 310 is made through all the layers of the LCD structure. For example, the hole 310 is made through the backlight layer 105, the first polariser 110, the bottom encapsulation layer 115, the LC cell bottom 120, the LC material 130, edge seal 125, LC cell top layer 135, the top encapsulation layer 140 and the second polariser 145. In one example, an optical device 305 is also provided within the hole (but partially near the lower polariser 110 and the backlight layer 105, or really close to the top). The optical device 305 could be a camera or an optical sensor such as an image sensor or motion sensor. In another example, a sound speaker may be located near the hole 310. Because the hole 310 is created through the LC material 130, the internal edge seal 315 is also provided adjacent the hole 310. The bonding spacer walls of the present disclosure are used to form the internal edge seal 315. The bonding spacer walls can also be used to form the external edge seal 125 of the display device of FIG. 2.

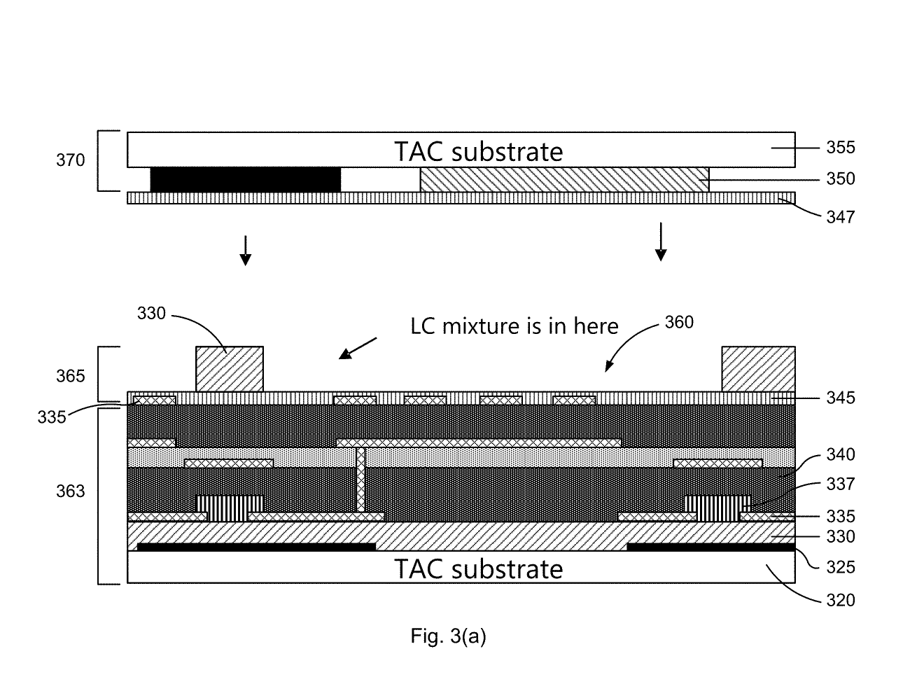

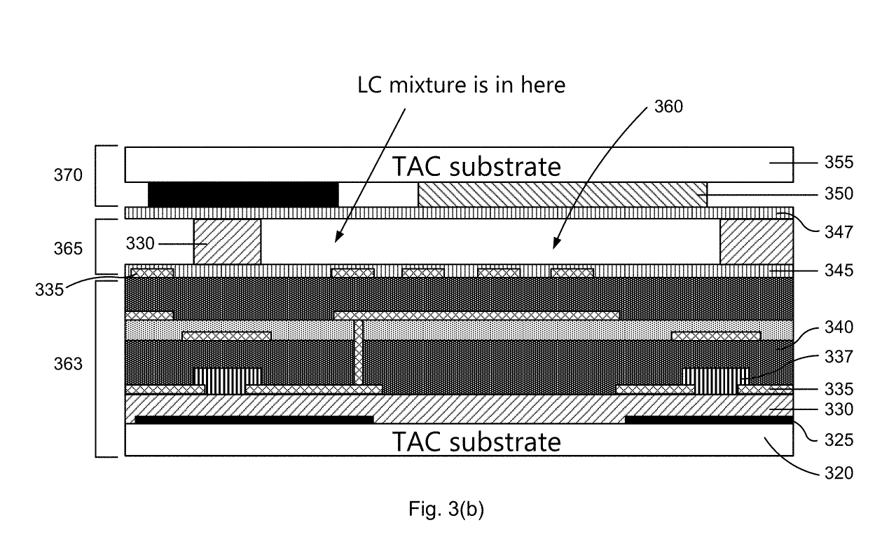

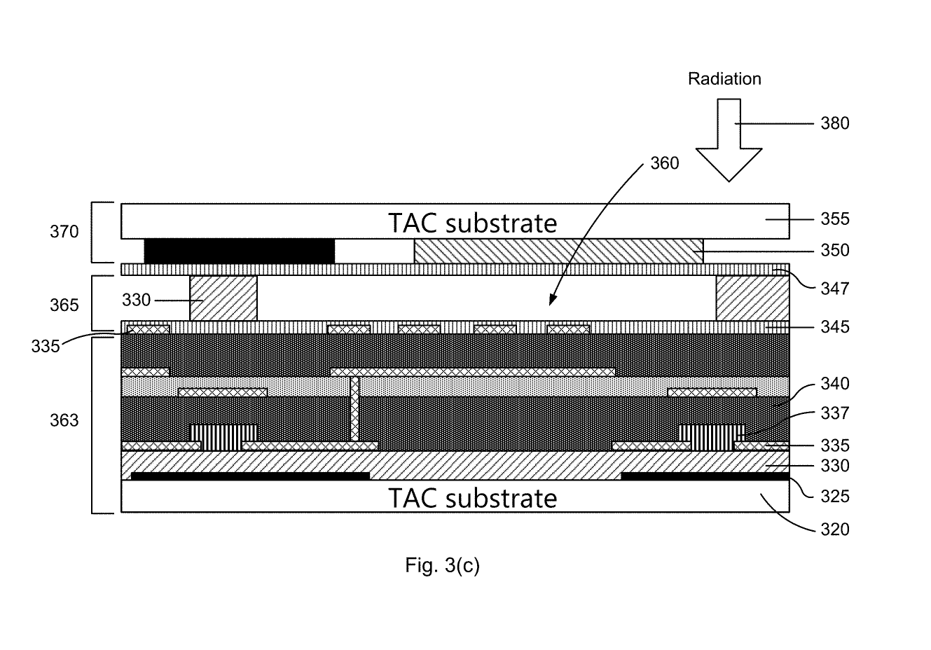

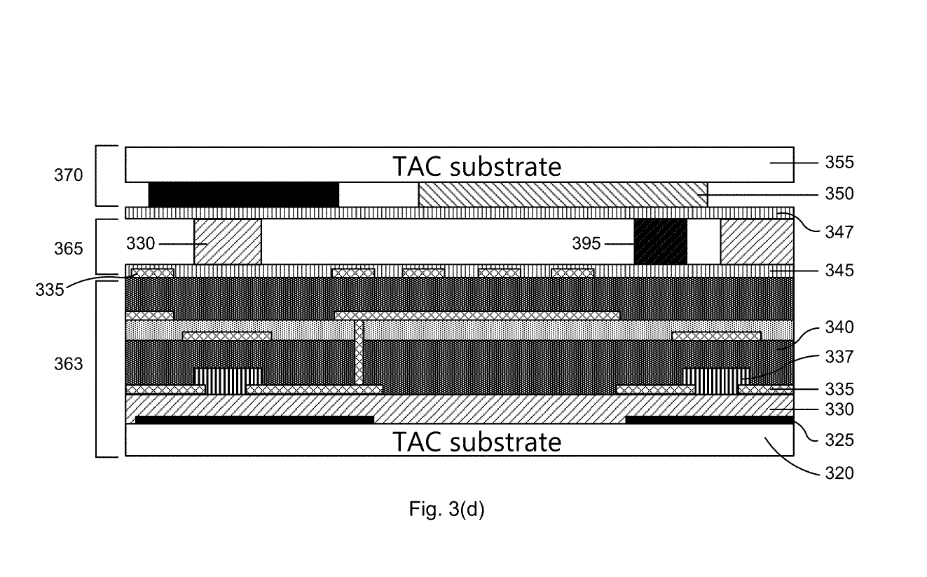

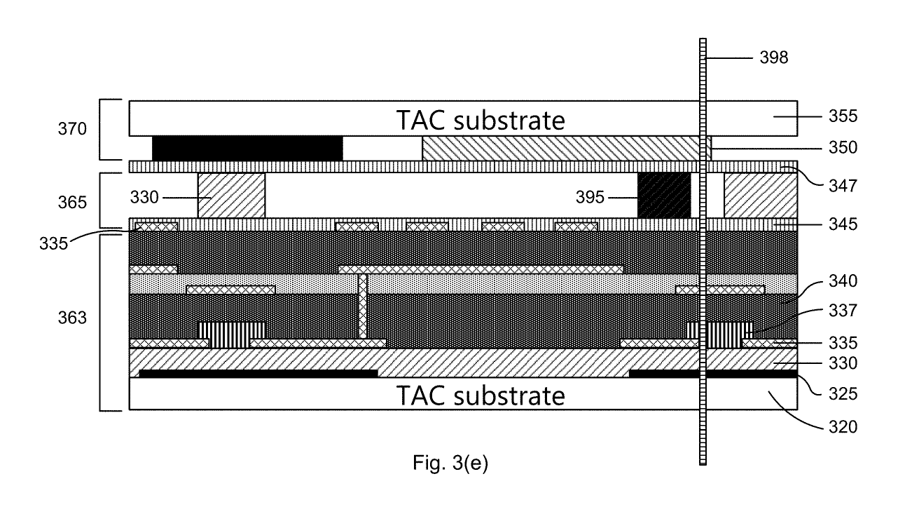

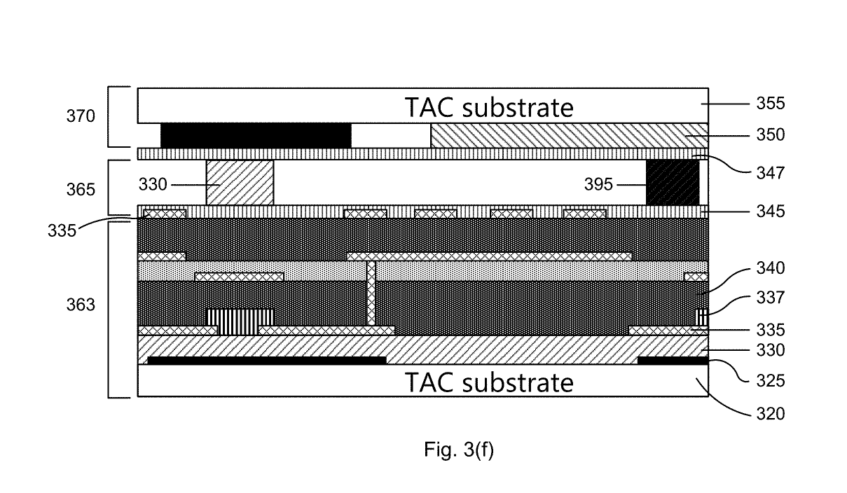

FIG. 3 generally illustrates the manufacturing steps of the display device according to one embodiment of the present disclosure, in which:

FIG. 3(a) illustrates a first step of assembling a display cell according to one embodiment. In this example, the LCD display includes a first substrate 355 and a second substrate 320. On top of the second substrate 320, an organic thin film transistor (OTFT) backplane unit 363 is formed. The OTFT backplane 363 includes BM/light shield 325, planarization/spacers 330, metal layers 335, organic semiconductors 337, and organic dielectrics 340. On top of the OTFT backplane 363, there is provided an LC front plane 365 including planarization/spacers 330 on a first alignment layer 345. During the assembling step of the display device, a second alignment layer 347 is located opposite to the first alignment layer 345 and there is a cell gap 360 between the first and second substrates 320 and 355. There is a colour filter 370 located on top of the second alignment layer 347, the colour filter including a colour filter resist 350. The mixture of LC material and radiation curable material are generally deposited in the cell gap 360.

FIG. 3(b) illustrates a second step of assembling a display cell in which an assembled display cell is shown. Many features of FIG. 3(b) are the same as those in FIG. 3(a) and therefore carry the same reference numbers. The LC material and UV curable material mix is located in the cell gap 360. The cell gap is sealed by planarization/spacers 330.

FIG. 3(c) illustrates a third step of the manufacturing process in which patterned UV radiation is used to a desired location for forming a bonding spacer wall. Many features of FIG. 3(c) are the same as those in FIG. 3(a) and therefore carry the same reference numbers. As shown, an UV radiation 380 is provided through a photomask (not shown) to the edge where the bonding spacer wall will be formed. In this example, the UV radiation 380 is provided at one edge of the display device.

FIG. 3(d) illustrates a fourth step of the manufacturing process in which a bonding spacer wall is formed connecting plates operatively connected with the first and second substrates. Many features of FIG. 3(d) are the same as those in FIG. 3(a) and therefore carry the same reference numbers. After shinning the UV light 380 at one edge, the radiation curable material is accumulated at the edge due to the influence of the UV radiation. After a predetermined period of radiation, the radiation curable material forms the bonding spacer wall 395. In one example, the bonding spacer wall 395 is a polymer spacer wall. The bonding spacer wall 395 rigidly bonds the top plate 347 and bottom plate 345. The top plate (or the second alignment layer) 347 is operatively connected with the first substrate 355 and the bottom plate (or the first alignment layer) is operatively connected with the second substrate 320. Therefore, the bonding spacer wall 395 bonds the first and second substrates 355, 320 through the top plate 347 and bottom plate 345.

FIG. 3(e) illustrates a fifth step of the manufacturing process in which the display is cut away after forming the bonding spacer wall. Many features of FIG. 3(e) are the same as those in FIG. 3(a) and therefore carry the same reference numbers. Once the desired area for sealing is defined by the bonding spacer wall 395, the display is cut away using a blade or a laser profiling technique 398.

FIG. 3(f) illustrates a display device after an edge is sealed using the bonding wall spacer after the display is cut away. Many features of FIG. 3(f) are the same as those in FIG. 3(a) and therefore carry the same reference numbers, but the right hand edge of the display is sealed using the bonding wall spacer 395 formed using UV radiation.

Generally speaking, FIGS. 3(a) to 3(f) illustrate the manufacturing steps forming an external edge seal for the display device. However, the same technique can also be used to make holes within the display device. For example, the UV light is generally used in the region where the holes will be made. Then bonding spacer walls are formed around the perimeter of the hole area. Then, in one example, the laser profiling technique is used to cut the hole.

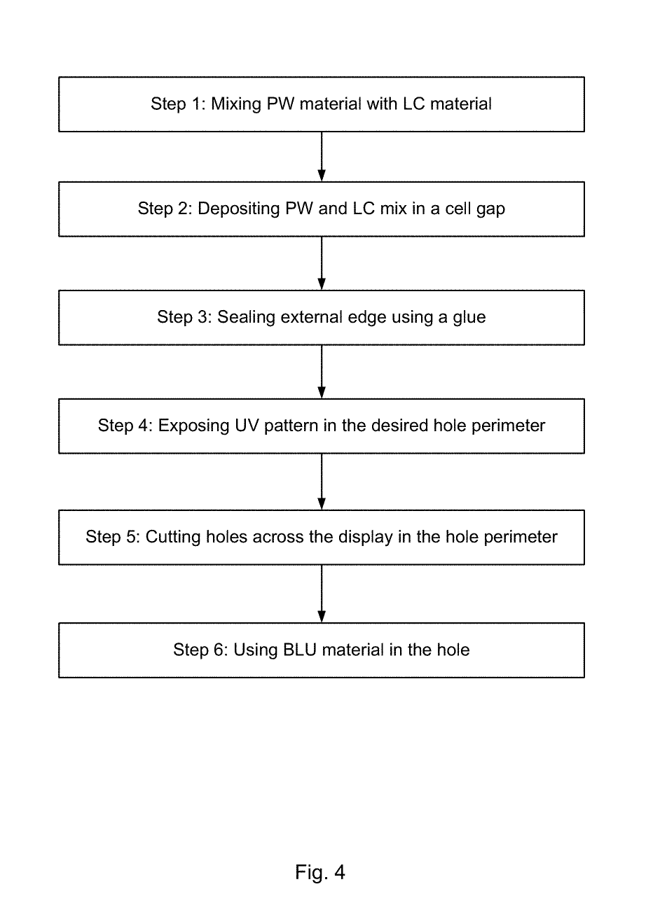

FIG. 4 illustrates the manufacturing steps of forming holes in the display device. In step 1, the light curable material, for example the polymer wall (PW) material, is included in the LC mixture and is then cured using a UV exposure through a photomask after cell assembly.

In step 2, the LC/light curable material mixture is deposited as usual onto the display design which takes account of the locations of the prospective perforations or holes.

In step 3, the edge seal for the outer perimeter of the display is formed in the usual way, for example using a glue or adhesive. Using the glue is not essential. This external edge can be also sealed using bonding wall spacers (or PW material) as described in FIG. 3 above.

In step 4, the display is exposed to a UV pattern that forms the bonding spacer walls (or PWs) as normal, but also forms addition circular walls around the perforation or hole locations.

In step 5, the display is generally laser profiled, including cutting out the perforations across the surface of the display. LC from the active area is prevented from leaking by the already-formed circular bonding spacer walls (or PWs).

In step 6, a BLU is used that takes account of the regular grid of holes—either by design of the edge-lit BLU, or by using an array for direct-lit with LEDs with a suitable pitch (optimal approach determined by the diameter, pitch of the holes and size of the active area).

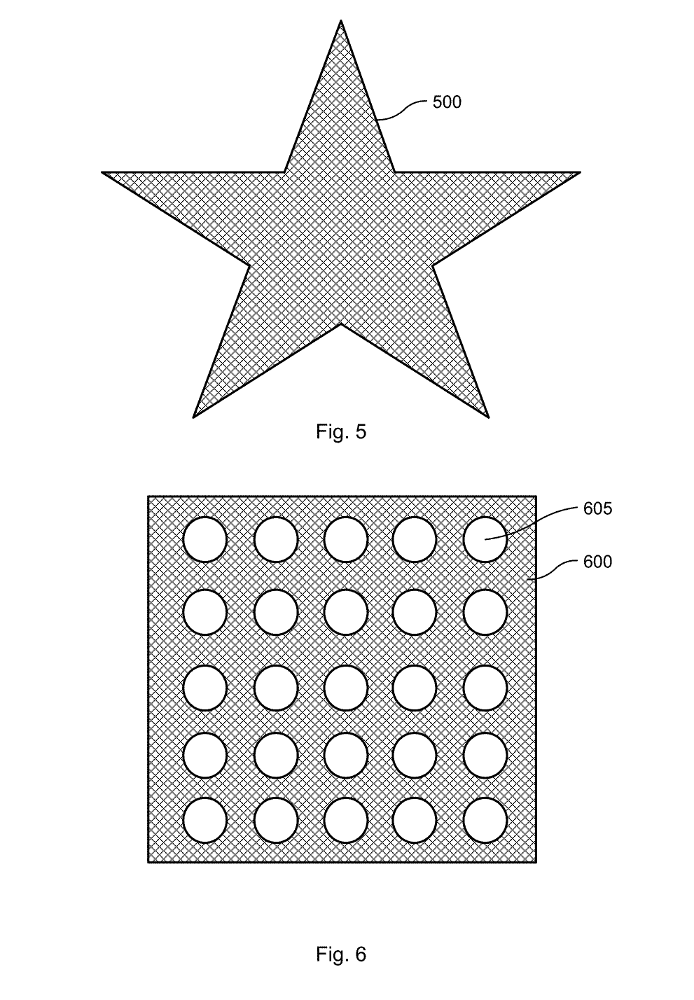

FIG. 5 illustrates a display device with a larger perimeter according to one embodiment. The display device 500 has a ‘star’ shape and the external sealing was formed using the technique described in FIG. 3. Given that the external sealing material was formed using the UV radiation, it is very fast and accurate to form the “star” shape. It is then convenient to cut away the shape outside the sealing area (or display area). Sealing a display having such a complex shape in a conventional way is difficult, inaccurate and time consuming. However, the light beam radiation technique to seal display devices proposed in this disclosure overcomes all these problems and is capable of producing displays with complex shapes. Although this example is directed to “star” shape, it would be appreciated that the same technique can be used to form displays having other complex shapes, for example, a corrugated shape.

FIG. 6 illustrates a display device with a plurality of holes or perforations across the device. The holes 605 are made using the technique described in FIG. 4 above. As discussed, the light beam radiation technique can form bonding wall sealing around the perimeter of each hole and then laser profiling or other methods are conveniently used to cut away each hole across the display device. It is difficult to create holes in displays having glass substrates. In particular, creating a large number of holes will be very difficult. This will also take a long time and the display sealing would not be very effective. However, as discussed in the present disclosure, the light radiation technique to form the internal LC sealing adjacent the holes will be advantageous, because it is possible to create a large number of (smaller) holes within a short time. The process can more accurately define the hole perimeter, as it is controllable by the light radiation device.

Although the description above uses the example of applying UV radiation, it will be appreciated that the disclosure is not limited to the use of UV radiation. Other types of radiation techniques could be used. The description above also uses the example of forming polymer wall spacers, but it would be appreciated that the disclosure is not limited to using the polymer material only. Other types of materials which are controllable by light radiation and able to bond both substrates could be used as well.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

1. A display device comprising:
a first plate;
a second plate spaced apart from the first plate to form a cell gap between the first and second plates;
a display medium material and a radiation curable material located within the cell gap;
wherein, upon exposure to radiation within a vicinity of a continuous target perimeter, the radiation curable material is configured to bond the first and second plates together within the vicinity of the continuous target perimeter.

2. A display device according to claim 1, wherein the vicinity of the continuous target perimeter is an area of the display device in which one side of the area has the display medium material and another side of the area has no display medium material.

3. A display device according to claim 1, wherein the vicinity of the continuous target perimeter is an area of the display device in which one side of the area has the display medium material and another side of the area has no display.

4. A display device according to claim 3, wherein said another side of the area is a hole through the display device.

5. A display device according to claim 3, wherein said another side of the area is outside the display device.

6. A display device according to claim 1, wherein the radiation curable material is configured to form at least one bonding spacer wall to bond the first and second plates.

7. A display device according to claim 6, wherein the at least one bonding spacer wall is a polymer wall.

8. A display device according to claim 1, wherein the continuous target perimeter is an outer perimeter of the display device.

9. A display device according to claim 1, wherein the continuous target perimeter is a perimeter of a perforated region within the display device.

10. A display device according to claim 9, wherein the perforated region is a hole through the first plate, the liquid crystal material in the cell gap and the second plate.

11. A display device according to claim 1, wherein the device is configured such that holes and/or edges of the target continuous perimeter are cut using a laser profiling technique.

12. A display device according to claim 1, wherein ultraviolet radiation is used to form the bonding wall spacer from the radiation curable material.

13. A display device according to claim 1, wherein the first and second plates are each a substrate.

14. A display device according to claim 1, further comprising a first substrate operatively connected with the first plate and a second substrate operatively connected with the second plate.

15. A display device according to claim 1, wherein the display medium material is a liquid crystal material.

16. A method of manufacturing a display device, the method comprising:
forming a first plate;
forming a second plate spaced apart from the first plate to form a cell gap between the first and second plates;
depositing a display medium material and a radiation curable material within the cell gap;
radiating the display medium material and the radiation curable material within a vicinity of a continuous target perimeter so that the radiation curable material bonds the first and second plates together within the vicinity of the continuous target perimeter.

17. A method according to claim 16, further comprising applying a patterned radiation to define the continuous target perimeter where the edge of the display device will be formed.

18. A method according to claim 16, further comprising applying a patterned radiation to define the continuous target perimeter where a perforated region within the display device will be formed.

19. A method according to claim 18, further comprising forming a bonding wall spacer in the continuous target perimeter.

20. A method according to claim 19, further comprising applying a laser profiling technique to form a hole through the device; and/or further comprising applying a laser profiling technique to form an edge seal of the display device.
